(19) United States
(12) Patent Application Publication
(10) Pub. No.: US 2013/0037158 A1
(43) Pub. Date: Feb. 14, 2013

(54) ENGINE EXHAUST ASSEMBLY

(71) Applicant: Jeffrey L. Gardner, Hudson, IA (US)

(72) Inventor: Jeffrey L. Gardner, Hudson, IA (US)

(21) Appl. No.: 13/207,865

(22) Filed: Aug. 11, 2011

(51) Int. Cl. F16L 9/18

(52) U.S. Cl. 138/114

(57) ABSTRACT

An engine exhaust assembly includes an inner pipe for connecting to an engine exhaust port. An outer pipe surrounds a portion of the inner pipe. The inner pipe and the upstream end of the outer pipe form an opening therebetween for receiving air from the environment. An annular cap fills a gap between the inner pipe and the downstream end of the outer pipe. A vent is formed in the inner pipe inside and adjacent to the downstream end of the outer pipe. The flow of exhaust through the inner pipe causes air from the environment to flow into the opening between the inner pipe and outer pipe, through the space between the pipes and into the inner pipe through the vent. The downstream end of the inner pipe projects or extends beyond the downstream end of the outer pipe.

### FIELD OF THE INVENTION

The present disclosure relates to an engine exhaust assembly.

### BACKGROUND OF THE INVENTION

Engine exhaust temperatures have increased because of engine emissions regulations. As a result, there is a need to cool the exhaust components of such engines.

### SUMMARY

According to an aspect of the present disclosure, an engine exhaust assembly includes an inner pipe and an outer pipe. The inner pipe has an upstream end for receiving exhaust from an engine and an open downstream end for communicating exhaust gasses to the environment. The outer pipe surrounds most of the inner pipe. The outer pipe has an upstream end and a downstream end. The inner pipe and the upstream end of the outer pipe form an opening therebetween for receiving air from the environment. An annular cap fills a gap between the. inner pipe and the downstream end of the outer pipe.

A vent is formed in the inner pipe inside and adjacent to the downstream end of the outer pipe, so that air flows into the opening, between the inner pipe and outer pipe and into the inner pipe through the vent. The downstream end of the inner pipe projects or extends beyond the downstream end of the outer pipe. The outer pipe has a solid wall which is formed without any openings therein.

The outer pipe encloses a passage for outside air to channel into the primary exhaust. The flowing air through the passage between the exhaust pipe and outer pipe will lower the temperature of the outer pipe and mix with the exiting air from the exhaust pipe. The outside pipe temperature will drop due to the air flow through the space between the pipes. The cooling air then mixes with the exiting exhaust. The result will be a lower exhaust and outer pipe temperature.

### BRIEF DESCRIPTION OF THE DRAWINGS

FIG. 1 is a simplified sectional view of an engine exhaust assembly embodying the invention.

### DETAILED DESCRIPTION OF THE DRAWINGS

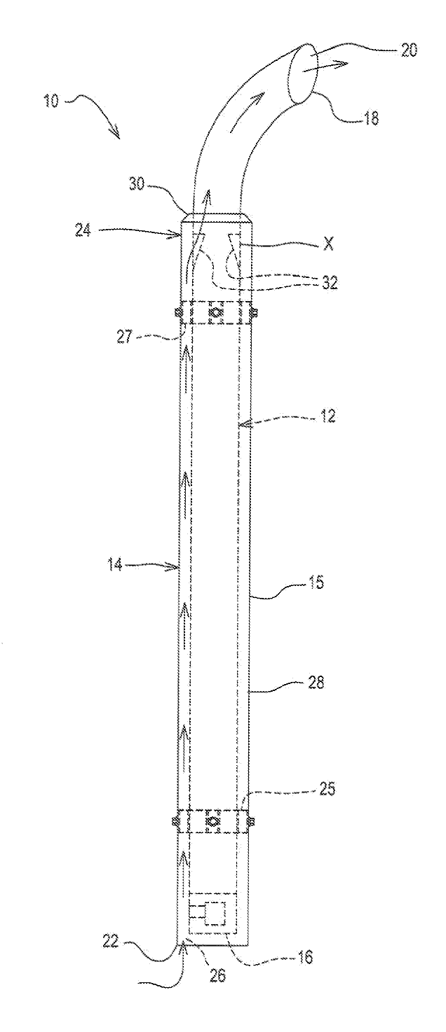

Referring to FIG. 1, an engine exhaust assembly 10 includes a hollow cylindrical inner pipe 12 and an outer pipe or shield 14. The inner pipe 12 has an upstream end 16 for connecting to an engine exhaust port (not shown) and a downstream end 18 with an opening 20 for communicating exhaust gasses to the environment. The main part of the inner pipe 12 is cylindrical, while the downstream end 18 may be curved.

The hollow cylindrical outer pipe 14 coaxially surrounds a portion of the inner pipe 12. Preferably, the outer pipe 14 coaxially surrounds substantially all or at least as much as possible of the inner pipe 12. The outer pipe 14 has an upstream end 22 and a downstream end 24. The inner pipe 12 and the upstream end 22 of the outer pipe 14 form an annular opening 26 therebetween for receiving air from the environment. The inner pipe 12 and the outer pipe 14 form an annular space 28 therebetween. An annular cap 30 fills a gap between the inner pipe 12 and the downstream end 24 of the outer pipe 14. The end 18 of the inner pipe 12 projects or extends beyond the downstream end 24 of the outer pipe 14. Brackets 25 and 27 hold the outer pipe 14 spaced apart from the inner pipe 12. The outer pipe 14 has a solid wall 15 which is formed without any openings therein.

A plurality of vents or apertures 32 are formed in the inner pipe 12 inside and adjacent to or near the downstream end 24 of the outer pipe 14. Then flow of exhaust gasses through the inner pipe 12 causes air from the environment to flow into the opening 26, through the annular space 28 between the inner pipe 12 and outer pipe 14, and into the inner pipe 12 through the vents 32. This air flow cools the outer pipe 14 so that it operates as a heat shield.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected.

It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

I claim:

1. An engine exhaust assembly, comprising:
an inner pipe having an upstream end for receiving exhaust from an engine and having an open downstream end for communicating exhaust gasses to the environment;
an outer pipe surrounding a portion of the inner pipe, the outer pipe having an upstream end and a downstream end, the inner pipe and the upstream end of the outer pipe forming an opening therebetween for receiving air from the environment;
an annular cap filling a gap between the inner pipe and the downstream end of the outer pipe; and
a vent in the inner pipe inside and adjacent to the downstream end of the outer pipe, so that air flows into the opening, between the inner pipe and outer pipe and into the inner pipe through the vent.

2. The engine exhaust assembly of claim 1, wherein:
the downstream end of the inner pipe projects or extends beyond the downstream end of the outer pipe.

3. The engine exhaust assembly of claim 1, wherein:
the outer pipe has a solid wall which is formed without any openings therein.

4. An engine exhaust assembly, comprising:
a hollow cylindrical inner pipe having an upstream end for receiving exhaust from an engine and having an open downstream end for communicating exhaust gasses to the environment;
a hollow cylindrical outer pipe surrounding a portion of the inner pipe, the outer pipe having an upstream end and a downstream end, the inner pipe and the upstream end of the outer pipe forming an annular opening therebetween for receiving air from the environment;
an annular cap filling a gap between the inner pipe and the, downstream end of the outer pipe; and
a plurality of apertures in the inner pipe inside and near to the downstream end of the outer pipe, so that exhaust flowing through the inner pipe draws air from the environment into the opening, between the inner pipe and outer pipe, through the apertures and into the inner pipe.

5. The engine exhaust assembly of claim 4, wherein:
the downstream end of the inner pipe projects or extends beyond the downstream end of the outer pipe.

6. The engine exhaust assembly of claim 4, wherein:
the outer pipe has a solid wall and is formed without any openings therein.
